(19) United States
(12) Patent Application Publication
(10) Pub. No.: US 2023/0322410 A1
(43) Pub. Date: Oct. 12, 2023

(54) HYDRAULIC STRUT SERVICING/DE-SERVICING TOOL

(71) Applicant: Villya, LLC, Melbourne, FL (US)

(72) Inventors: William Miller, Melbourne, FL (US); Greg Swan, Ronan, MT (US)

(21) Appl. No.: 18/298,907

(22) Filed: Apr. 11, 2023

Related U.S. Application Data
(60) Provisional application No. 63/366,193, filed on Jun. 10, 2022.
(60) Provisional application No. 63/344,292, filed on May 20, 2022.
(60) Provisional application No. 63/329,780, filed on Apr. 11, 2022.

(51) Int. Cl. B64F 5/40; B64F 5/60; B64C 25/60; F04B 49/22; F04B 19/04

(52) U.S. Cl. CPC B64F 5/40; B64F 5/60; B64C 25/60; F04B 49/225; F04B 19/04; F04B 2205/05

(57) ABSTRACT

A servicing tool may provide a portable, lightweight solution to adjusting the height of struts of aircraft. The tool may provide hydraulic fluid at high pressure to an already pressurized strut. The hydraulic fluid may be supplied to the strut by the tool at a pressure in excess of a pressured gas in the strut to increase the height of the strut. The tool provides techniques to raise and lower the strut when access to high-pressure gas is unavailable. Further, with the application of high-pressure hydraulic fluid, the tool may be used to increase the strut height while also increasing the stiffness of the strut so as to reduce a risk of dynamic rollover.

### CROSS-REFERENCE TO RELATED APPLICATIONS

This patent application claims priority to and the benefit of U.S. Provisional Patent Application No. 63/329,780, filed Apr. 11, 2022, U.S. Provisional Patent Application No. 63/344,292, filed May 20, 2022, and U.S. Provisional Patent Application No. 63/366,193, filed Jun. 10, 2022, each of which is incorporated herein by reference in its entirety.

### FIELD OF USE

Aspects of the disclosure relate generally to a hydraulic strut and brake servicing/de-servicing tool, including a tool operable to service struts and/or brakes (e.g. helicopter landing gear struts and/or brakes) without access to standard servicing equipment.

### BACKGROUND

Helicopters and/or other aircraft may utilize pneumatic air-oil hydraulic shock absorbers known as oleo struts. Oleo struts may include a cylinder and a piston that moves up and down in the cylinder. The cylinder of the oleo struts may be filled with a combination of hydraulic fluid and one or more gases, such as nitrogen gas (or other gas as desired).

The oleo struts are adapted to compress as the weight of the aircraft is transferred to the landing gear as the aircraft lands. The piston compresses the gas, which creates resistance to the movement of the piston and absorbs the energy of the landing. The hydraulic fluid aids in dampening the movement of the piston and controlling the rebound of the strut.

While most full-service airports may provide compressed gas (e.g. nitrogen) for servicing the oleo struts, remote landing strips may lack the facilities to provide the high-pressure gas service. The lack of available high-pressure gas when in the field makes servicing in remote operations difficult. Further portable generators and/or compressed gas tanks require more complex infrastructure and mechanisms, as well as add extra weight that may complicate loading requirements of the aircraft.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates servicing tool attached to a strut of an aircraft according to one or more aspects of the disclosure.

FIG. 2 illustrates a servicing tool attached to a strut of an aircraft with an open-ended reservoir according to one or more aspects of the disclosure.

FIG. 3 illustrates a left-side view of a servicing tool mounted on a base according to one or more aspects of the disclosure.

FIG. 4 illustrates a right-side view of a servicing tool mounted on a base according to one or more aspects of the disclosure.

FIG. 5 illustrates a servicing tool and reservoir according to one or more aspects of the disclosure.

FIG. 6 illustrates a reservoir, pump, hydraulic line, base, and pump of a servicing tool position in the storage container according to one or more aspects of the disclosure.

FIG. 7 illustrates a servicing tool with a coupling according to one or more aspects of the disclosure.

FIG. 8 illustrates a servicing tool with a multi-coupling configuration according to one or more aspects of the disclosure.

FIG. 9 illustrates a servicing tool with a pump attached to a reservoir having a level indicator according to one or more aspects of the disclosure.

FIG. 10 illustrates a servicing tool having a coupling and removable handle according to one or more aspects of the disclosure.

FIG. 11 illustrates a servicing tool having one or more flow control valves, a level indicator, and a plurality of couplings according to one or more aspects of the disclosure.

FIG. 12 illustrates a servicing tool having a multi-coupling configuration, where the servicing tool is connectable to one or more additional reservoirs according to one or more aspects of the disclosure.

FIG. 13 illustrates a servicing tool having one or more flow control valves, a level indicator, a filter, a pressure gauge, and a plurality of couplings according to one or more aspects of the disclosure.

FIG. 14 illustrates a servicing tool having a multi-coupling configuration, a filter, a pressure gauge, and one or more removable additional reservoirs according to one or more aspects of the disclosure.

FIG. 15 illustrates an example of an oleo-strut according to the disclosure.

FIG. 16 is a flowchart of a servicing method to raise a strut according to one or more aspects of the disclosure.

FIG. 17 is a flowchart of a servicing method to lower a strut according to one or more aspects of the disclosure.

The exemplary embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

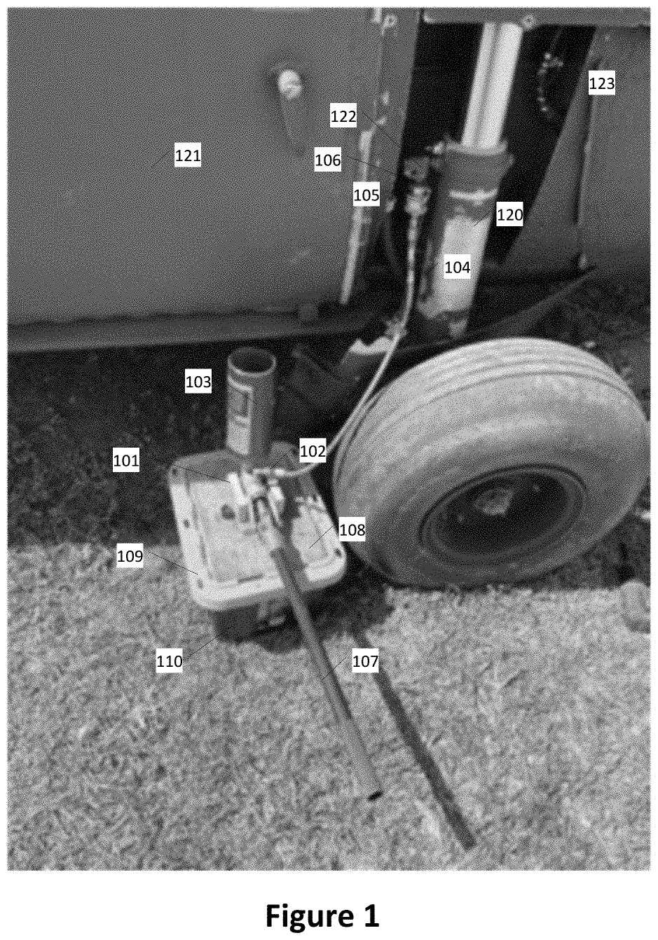

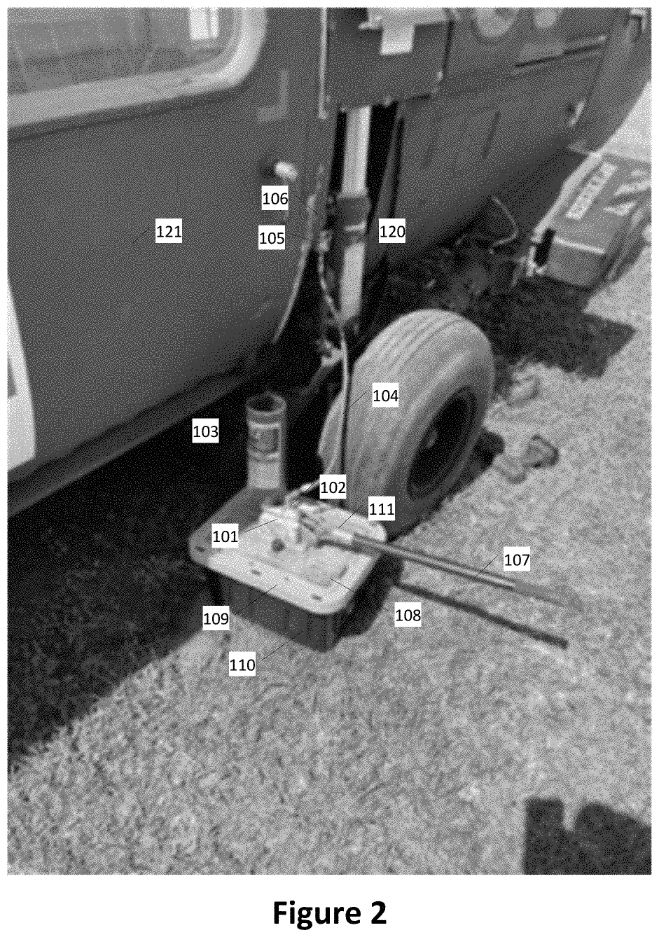

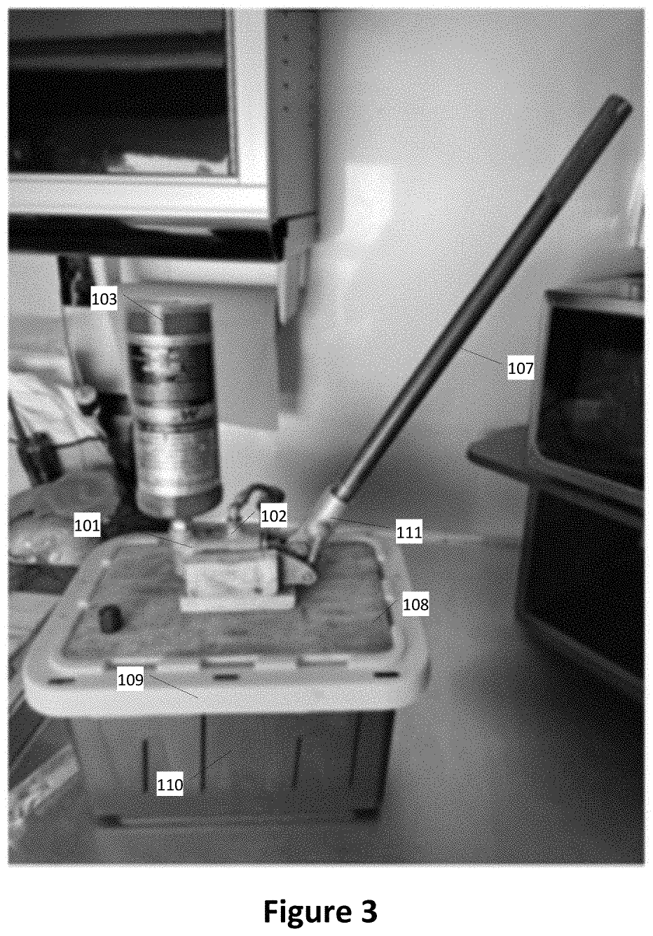

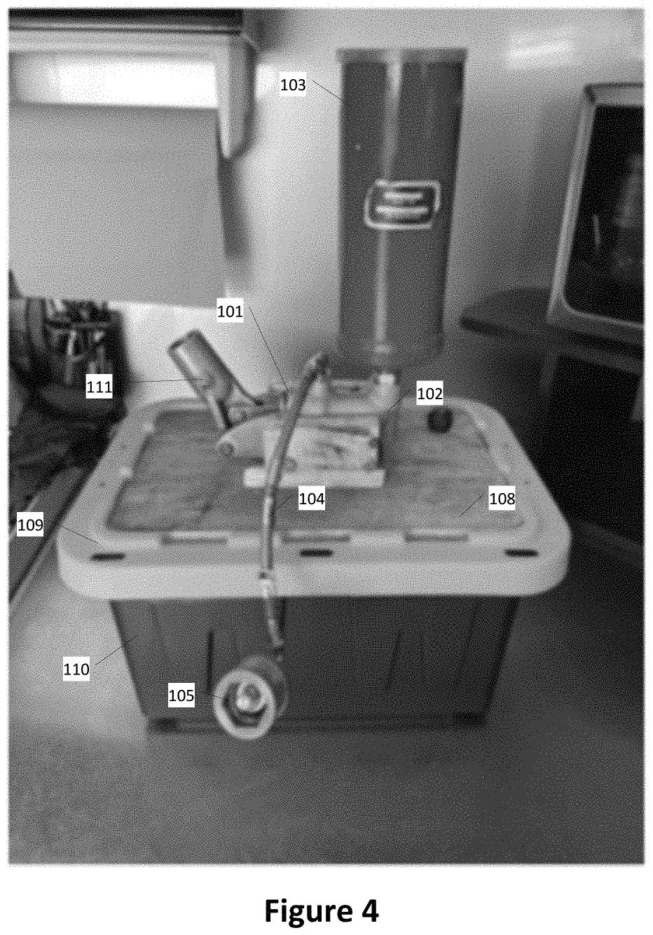

The following describes a hydraulic strut and brake servicing/de-servicing tool for struts, such as struts configured to be filled with a combination of hydraulic fluid and one or more gases. FIGS. 1-4 show the servicing tool 101 according to one or more exemplary embodiments. FIGS. 1 and 2 show the servicing tool 101 attached to a strut 120 of an aircraft 121. FIGS. 3 and 4 show side views of the servicing tool 101 detached from the strut 120.

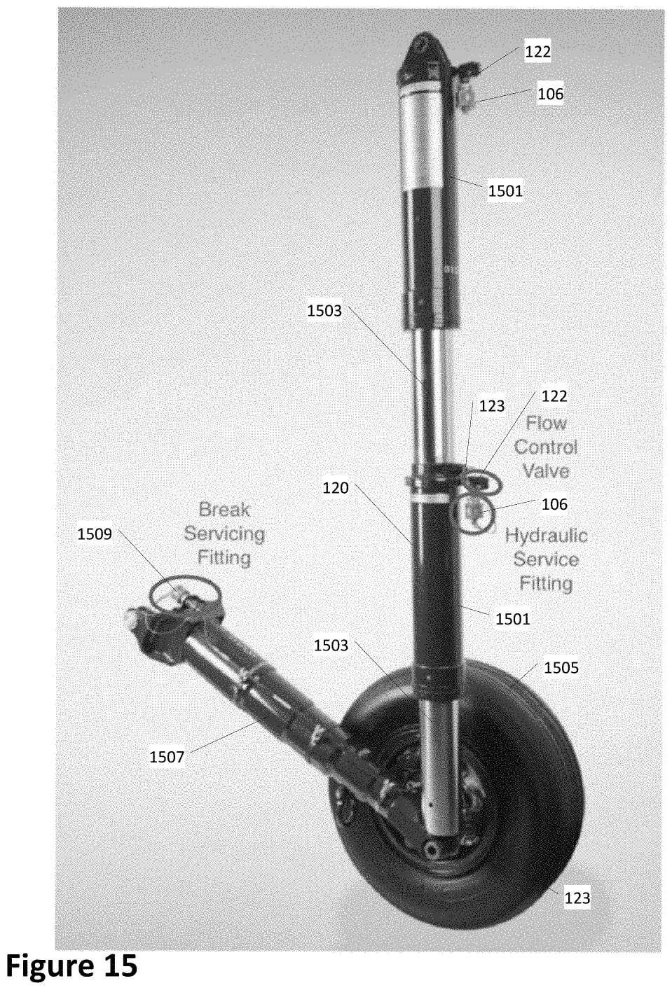

In one or more aspects, the tool 101 is configured to service struts 120, such as oleo struts (e.g. oil-air strut, or pneumatic air-oil hydraulic shock absorbers). Oleo struts 120 may be filled with hydraulic fluid (e.g., MIL-PRF-5606) at a low pressure to reach a minimum length. The oleo strut 120 may also be filled at high pressure with a gas, such as nitrogen gas (or other gas as desired). FIG. 15 illustrates an example of the oleo-strut 120. The strut 120 may include a cylinder 1501 and a piston 1503, where the piston 1503 may be attached to a wheel 1505 on the lower end, where the upper end of the strut may connect to the aircraft 121. The wheel 1505 may also include a brake assembly 1507 having a coupling 1509. The servicing tool 101 may be configured to connect to the brake coupling 1509 to add or remove hydraulic fluid to the brake assembly 1507 in one or more aspects.

The strut 120 may include a hydraulic fluid coupling 106 and flow control valve 122 that is configured to open and close the flow through the hydraulic fluid coupling 106. The servicing tool 101 is configured to connect to the hydraulic fluid coupling 106 to add hydraulic fluid into (e.g. at high pressure) or remove hydraulic fluid from the strut 120.

Oleo struts 120 are generally filled with a low-pressure hydraulic fluid (e.g., MIL-PRF-5606) to reach a minimum length, installed on a landing gear of the aircraft 121, filled (if needed) at low pressure with additional hydraulic fluid, and then filled at high pressure with nitrogen gas (or other gas as desired). An oleo strut 120 may be single-ended or double-ended. FIG. 15 illustrates a double-ended strut 120. Single-ended oleo struts have a piston 1503 that is attached to one end of the cylinder 1501 (e.g. an internal reservoir) and a fixed strut at the other end. Single-ended oleo struts may be used in applications where the strut only needs to absorb compression forces. Double-ended oleo struts have pistons 1503 attached to respective cylinders 1501 and may be used in applications where both compression and tension forces need to be absorbed. The respective cylinders 1501 may each include a movable puck that is configured to divide the internal reservoir formed by the cylinder 1501 into a hydraulic chamber and a gas chamber.

The cylinder 1501 of the strut 120 may include two couplings-a hydraulic fluid coupling 106 and a gas coupling 123. In dual-ended configurations, the oleo strut may include two hydraulic fluid couplings 106 and two gas couplings 123, where each of the two cylinders 1501 includes a hydraulic fluid coupling 106 and a gas coupling 123. The cylinder 1501 may include a vent port that may be opened to fill and/or drain low-pressure hydraulic fluid from the cylinder (e.g. an internal reservoir of the strut). The hydraulic fluid coupling 106 may include a flow control valve 122 that is configured to open and close the flow through the hydraulic fluid coupling 106. The gas coupling 123 may additionally include a flow control valve in one or more aspects.

Although the struts 120 are generally filled with hydraulic fluid at low pressure, the strut 120 may include a hydraulic flow control valve 122 and hydraulic fluid coupling 106 configured and rated for high pressures of 3000 pounds per square inch (psi) or more. Further, the strut 120 may include a high-pressure gas flow control valve and coupling 123 (e.g., a threaded Schrader valve from the Schrader Pacific corporation of Altavista, Virginia) of 3000 psi or more. The gas valve and coupling 123 may be used to provide compressed gas (e.g., nitrogen gas) to adjust the extension of the strut 120 as desired.

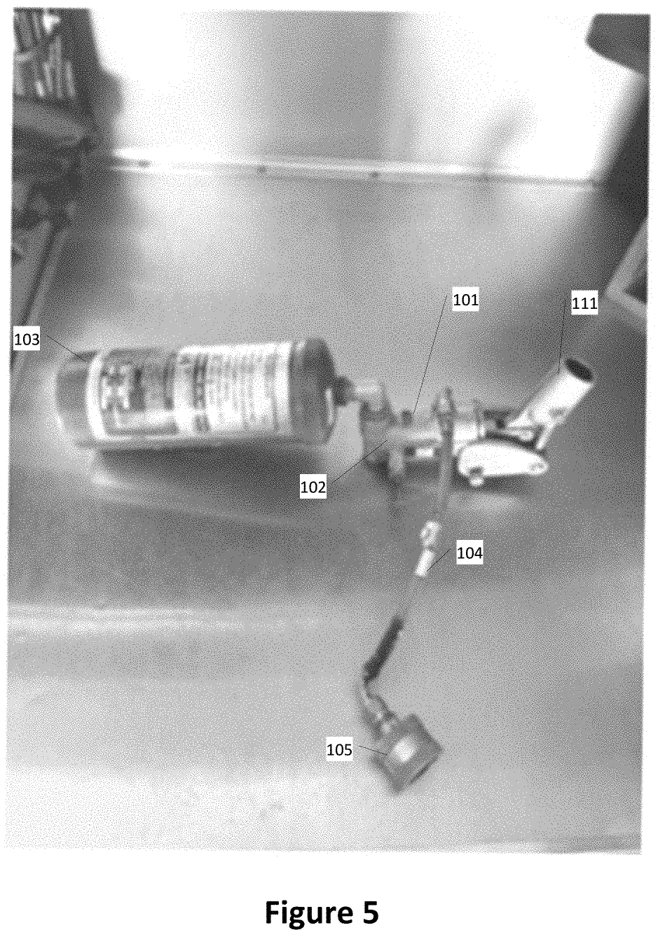

Various helicopters 121 (as well as other aircraft) use oleo struts 120 (i.e., pneumatic air-oil hydraulic shock absorbers). The tool 101 may be used for servicing aircraft (e.g. helicopter) landing gear struts 120 and/or brakes without access to standard servicing equipment. The tool 101 may comprise a manual-powered hydraulic pump 102 with an open (or closed) reservoir 103, hose 104, and quick disconnect coupling 105 for attaching to a strut 120 of the aircraft (e.g. to the hydraulic coupling). The pump 102 may be actuated using a removable or fixed handle 107 that is configured to engage with actuator 111 of the servicing tool 101. Although aspects are described with respect to a manually-powered pump, the tool 101 may include a motorized and/or electric pump, and/or the actuator (e.g. pump arm, foot pedal) of the pump 102 may be actuated by another motorized device, in one or more aspects. The reservoir 103 may be connected to the pump 102 in a traverse arrangement as shown in FIGS. 1-4, where the reservoir 103 extends transversely to the length of the pump 102. Alternatively, the reservoir 103 may be connected to the pump 102 in a parallel arrangement as shown in FIG. 5, where the reservoir 103 extends parallel to the length of the pump 102. In the parallel arrangement, the reservoir 103 may be connected to the pump 102 using a right-angled coupling. Other arrangements using other angled couplings are possible based on the specific needs of an implementation (e.g., using a 1350 coupling).

While most full-service airports may be able to provide compressed nitrogen gas for the oleo struts 120, remote landing strips may lack the facilities to provide the high-pressure nitrogen gas to return the oleo struts 120 to an operating height. Conventional approaches include carrying portable generators and/or compressed nitrogen tanks in the cargo aircraft or in the stowed aircraft. Each of these approaches requires more complex infrastructure and/or mechanisms, and/or adds extra weight that may complicate loading requirements of the cargo aircraft and/or the stowed aircraft. Further, the various struts of a helicopter may need to be adjusted at different times while loading and/or unloading to accommodate the approach angle at the bottom of a cargo bay ramp and the break-over angle at the top of the ramp. This may mean that the helicopter's landing gear's approach angle, departure angle, and break-over angle may need to be adjusted at different times to ensure antennas and/or other equipment on the belly of the helicopter do not contact the ground, ramp, or cargo floor while simultaneously ensuring the top of the rotor mast and/or top of the tail fin do not contact the head of cargo door opening or other parts of the cargo aircraft. Further, in some situations, a height of a helicopter 121 may need to be adjusted in the field where no high-pressure air supply is available. For instance, where a helicopter 121 is used to ferry water to a fire using different size water tanks, individual tanks may need to be swapped in the field where a compressed air supply is not available.

One or more aspects relate to servicing aircraft where conventional servicing tools are unavailable. The servicing tool 101 according to one or more exemplary embodiments may provide a portable, lightweight solution to adjusting the height of struts 120 of aircraft 121. One or more aspects relate to providing a servicing tool 101 that may provide hydraulic fluid at high pressure (e.g. at a pressure in excess of the pressured gas in the strut) to an already pressurized strut 120 but where the quantity of gas in the strut is low than desired for a given purpose. For example, a strut 120 may have been depressurized to decrease the height of the aircraft 121 for transport. In another example, a height of the aircraft 121 may need to be temporarily increased to permit installation of components to or removal of components from an underside of the aircraft 121. In some situations, lifting a landing gear assemblage via a jack is not possible as lifting points for the assemblage interfere with attachment locations for the components to be attached or removed. To provide additional clearance and access to the attachment locations, the servicing tool may be used to adjust the length of the struts without requiring an external jack.

Benefits of the servicing tool 101 include compact size and reduced weight yet with the ability to adjust the height of the aircraft 121 by adjusting the length of the strut 120. Instead of carrying tanks of compressed gas and/or powered air compressors providing in excess of 3000 psi, the servicing tool 101 may be used to provide hydraulic fluid at high pressure (e.g. at 3000 psi or more) to the strut via a hydraulic port generally only used low-pressure hydraulic applications (e.g. the filling of the strut with hydraulic fluid at low pressure prior to high pressure filling with compressed nitrogen (or other compressed gas)). By applying the hydraulic fluid at high pressure, the length of the strut 120 may be adjusted without the application of additional high-pressure compressed gas. Further, with the application of hydraulic fluid at high pressure to extend the strut 120, the stiffness of the strut 120 can be increased. The increased stiffness of the strut 120 advantageously reduces the risk of dynamic rollover that may be caused by extended struts having overly springing movements.

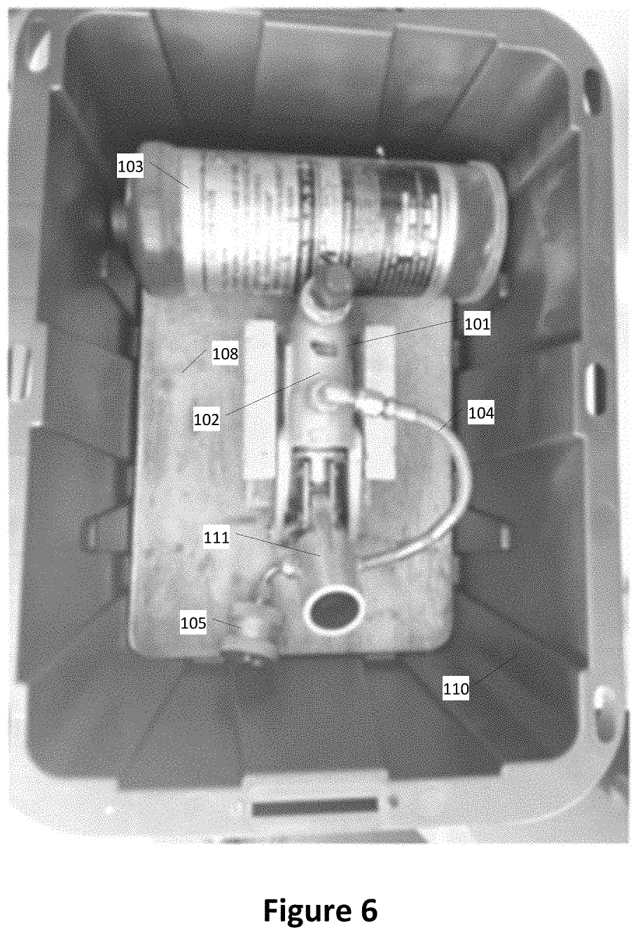

As shown in FIGS. 1-4, the servicing tool 101 may be fixed to a base 108. The base 108 may be configured to securely engage with a cover or lid 109 of a storage container 110 that is configured to store the tool 101 when not in use. The base 108 of the servicing tool 101 may be disposed on the top of the cover 109, and configured to mate with the contours of the cover 109. The cover 109 may include one or more recesses and/or protrusions configured to hold the base 108 to prevent relative horizontal movement between the base 108 and the cover 109. FIG. 6 shows the servicing tool 101 positioned in the storage container 110. In this stored configuration, the reservoir 103 may be disconnected from the pump 102. In one or more aspects, the storage container 110 may include one or more additional support structures (e.g., legs, etc.) configured to attach to (and/or extend from) the storage container 110 to prevent rotation of the storage container 110 and/or servicing tool 101 position thereon while in operation. Further, the base 108 may be attached to the cover/lid 109 of the storage container 110 (e.g., via latches or the like) to prevent rotation of the base 108 to the storage container 110 while using the servicing tool 101.

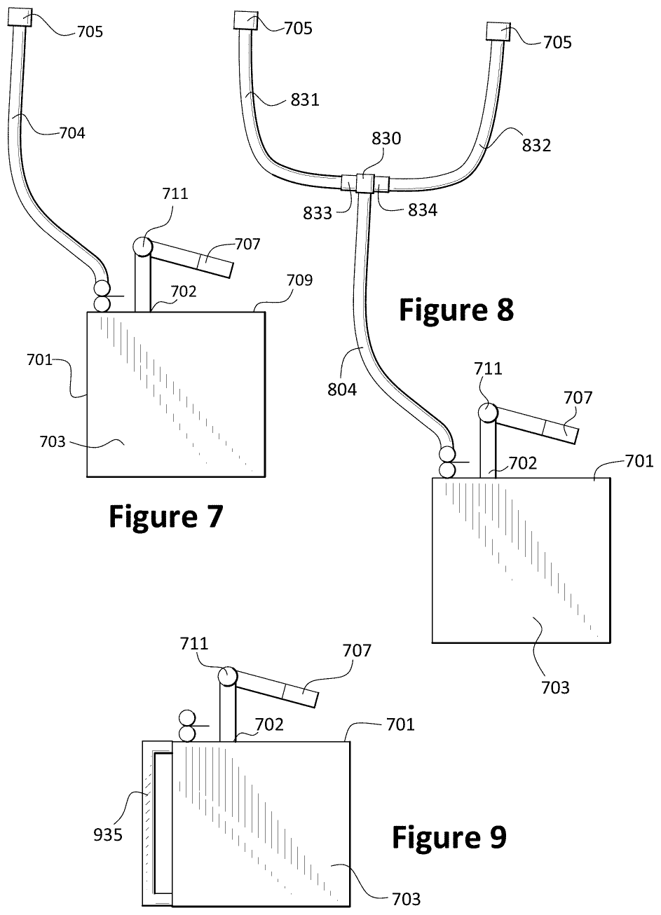

FIG. 7 shows a servicing tool 701 according to one or more exemplary embodiments. The servicing tool 701 is similar to the servicing tool 101, but pump 702 of the servicing tool 701 is positioned on top of reservoir 703. The pump 702 may be fixed to a cover or lid 709 that closes off the top of the reservoir 703. The servicing tool 101 may include a coupling 705 (e.g. quick disconnect coupling) configured to attach to a strut 120. The coupling 705 may be connected to the pump 702 via a hose (e.g. hydraulic fluid line) 704. The pump 702 may be operated by actuator 711. Handle 707 may be removably or fixedly connected to the actuator 711.

FIG. 8 shows the servicing tool 701 that includes a hose 804. The hose 804 is similar to hose 704, but includes an adapter 830 that is configured to split the hose 804 into two or more hose segments 831, 832. The hose segments 831, 832 can be connected to respective couplings 705. The couplings 705 for the respective hose segments 831, 832 may be the same or different. In an exemplary embodiment, the adapter 830 is a tee connector configured to allow the hydraulic fluid in reservoir 703 to be provided to both couplings 705. This allows for two struts or both ends of a dual-end strut to be serviced simultaneously. In an exemplary embodiment, the hose 804 may include individual shut-off valves 833 and 834 between the adapter 830 and the respective couplings 705. The individual shut-off valves 833, 834, when both open, permit the struts to be raised or lowered together. When one valve is open and the other closed, the height of one strut may be adjusted relative to another. For instance, when on uneven ground or when needing to account for odd-dimensioned belly tanks, one may selectively control the height of one strut compared to another and then easily switch to controlling both struts together.

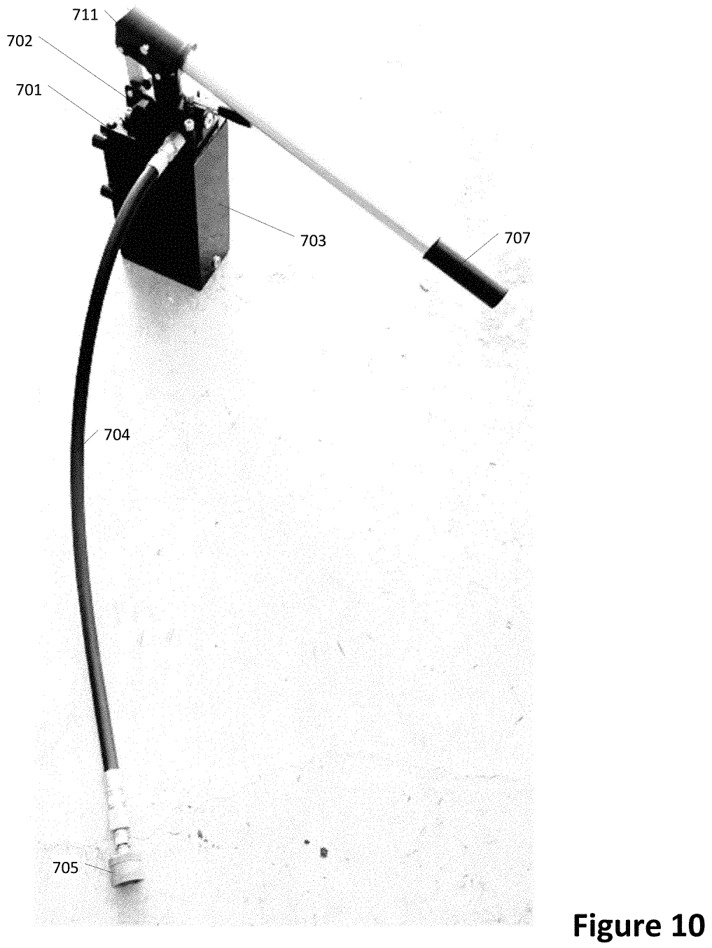

FIG. 9 shows servicing tool 701 according to an exemplary embodiment. The embodiment illustrated in FIG. 9 is similar to the embodiments illustrated in FIGS. 7 and 8, but the servicing tool 701 shown in FIG. 9 further includes a level indicator 935 on the side of the reservoir 703. The level indicator 935 is configured to indicate a level of fluid within the reservoir 703. The hose 704, 804 of the servicing tool 701 may be removable in one or more aspects, and the embodiment illustrated in FIG. 9 shows the servicing tool 701 without the hose 704, 804. FIG. 10 shows an embodiment of the servicing tool 701. In this embodiment, the coupling 705 is female coupling.

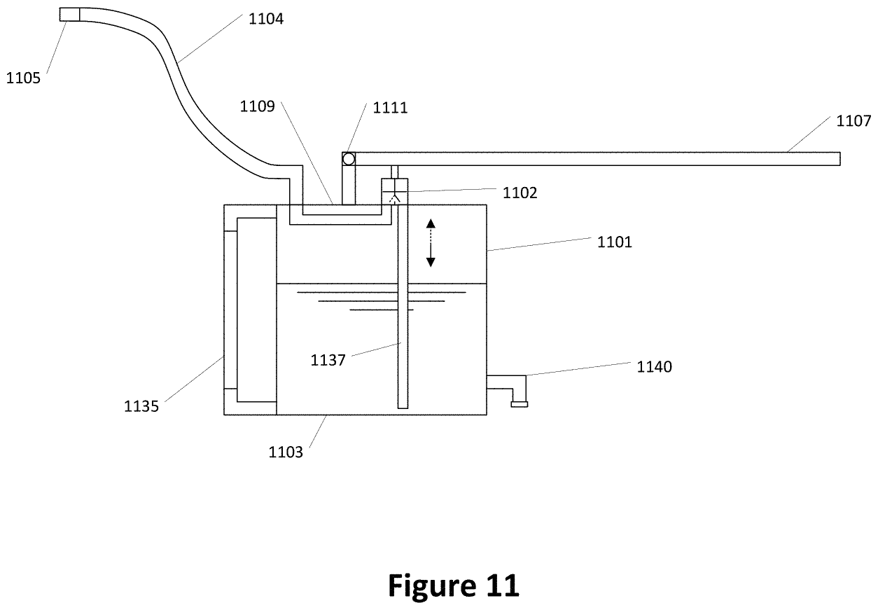

FIG. 11 shows a servicing tool 1101 according to an exemplary embodiment. The servicing tool 1101 is similar to tools 101 and 701, and discussion of similar functions and/or features may be omitted for brevity. The servicing tool 1101 may include pump 1102 that may be fixed to a cover or lid 1109 that closes off the top of the reservoir 1103. The servicing tool 1101 may include a coupling 1105 (e.g. quick disconnect coupling) configured to attach to a strut 120. The coupling 1105 may be connected to the pump 1102 via a hose 1104. The pump 1102 may be operated by actuator 1111. Handle 1107 may be removably or fixedly connected to the actuator 711. The pump 1102 may include a reservoir tube 1137 that extends to the bottom or near the bottom of the reservoir 1103 and is configured as the input of the pump 1102. The fluid within the reservoir 1103 is supplied to the pump 1102 via the reservoir tube 1137. In an exemplary embodiment, the servicing tool 1101 may include a level indicator 1135 reservoir outlet 1140. The reservoir outlet 1140 may be configured to connect the reservoir 1103 to another reservoir to increase the volume of fluid useable by the servicing tool 1101. The reservoir 1103 may also be filled or emptied via the reservoir outlet 1140.

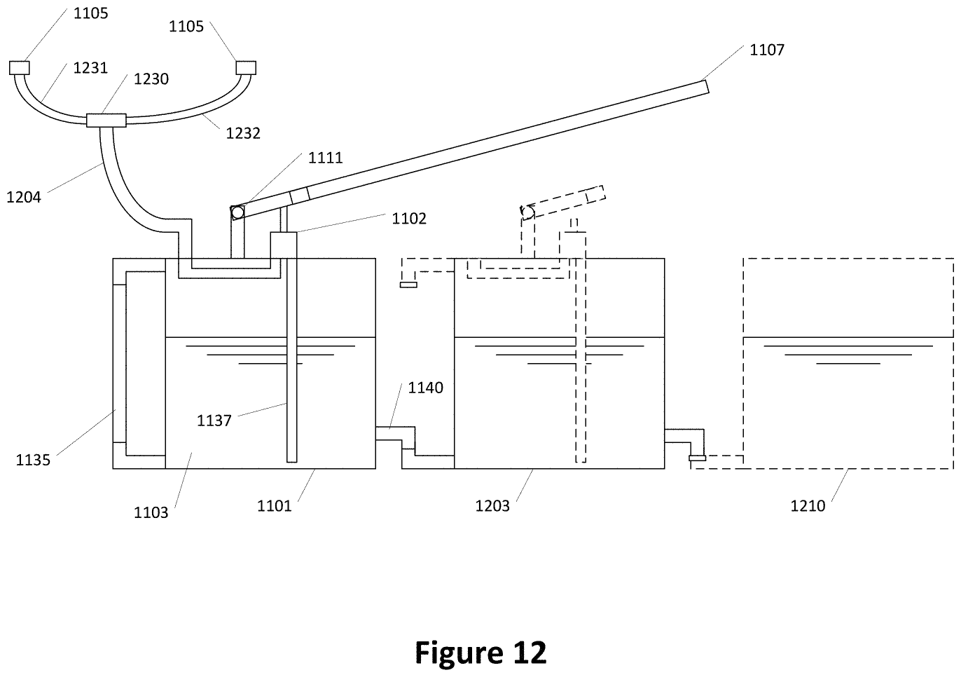

FIG. 12 shows servicing tool 1101 according to an exemplary embodiment. The embodiment of FIG. 12 is similar to the servicing tool 1101 illustrated in FIG. 11, but includes hose 1204 that includes adapter 1230 that is configured to split the hose 1204 into two or more hose segments 1231, 1232 similar to the embodiment illustrated in FIG. 8. The hose segments 1231, 1232 can be connected to respective couplings 1105. The couplings 1105 for the respective hose segments 1231, 1232 may be the same or different.

FIG. 12 also shows one or more additional reservoirs 1203 connected to the servicing tool 1101 via a reservoir outlet 1140 of the servicing tool 1101. In the example of FIG. 12, a middle reservoir 1203 may be another servicing tool with the pump handle removed and connected via a separate reservoir coupling or a coupling for the level indicator having been redirected to attach to the reservoir outlet 1140 of the left servicing tool 1101. Further, as an additional example, yet another reservoir 1210 with or without the pump assembly may be connected to the middle reservoir 1203 to provide additional hydraulic fluid to the servicing tool 1101 as needed.

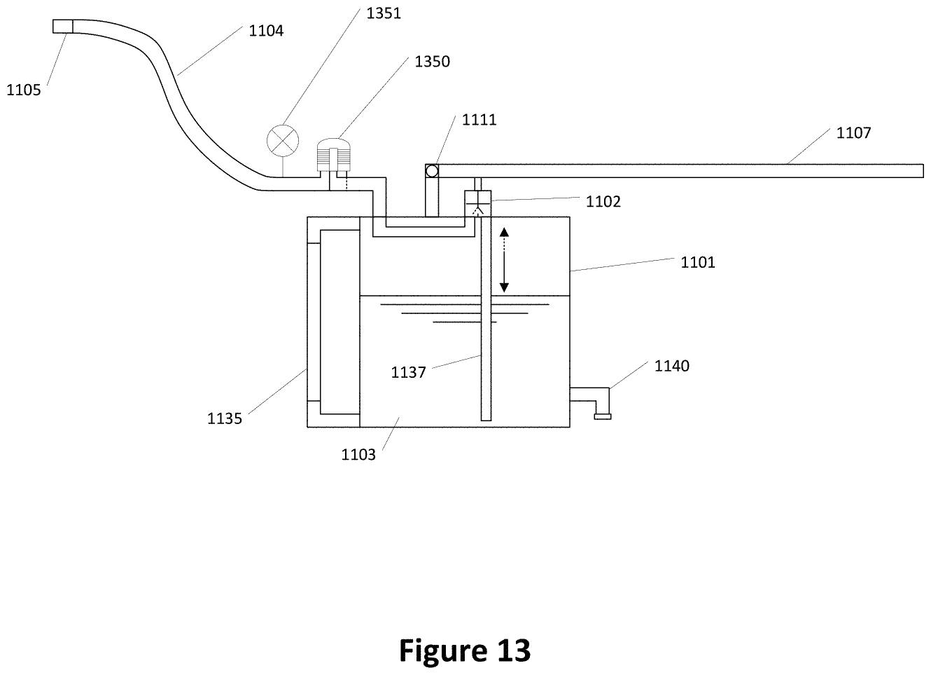

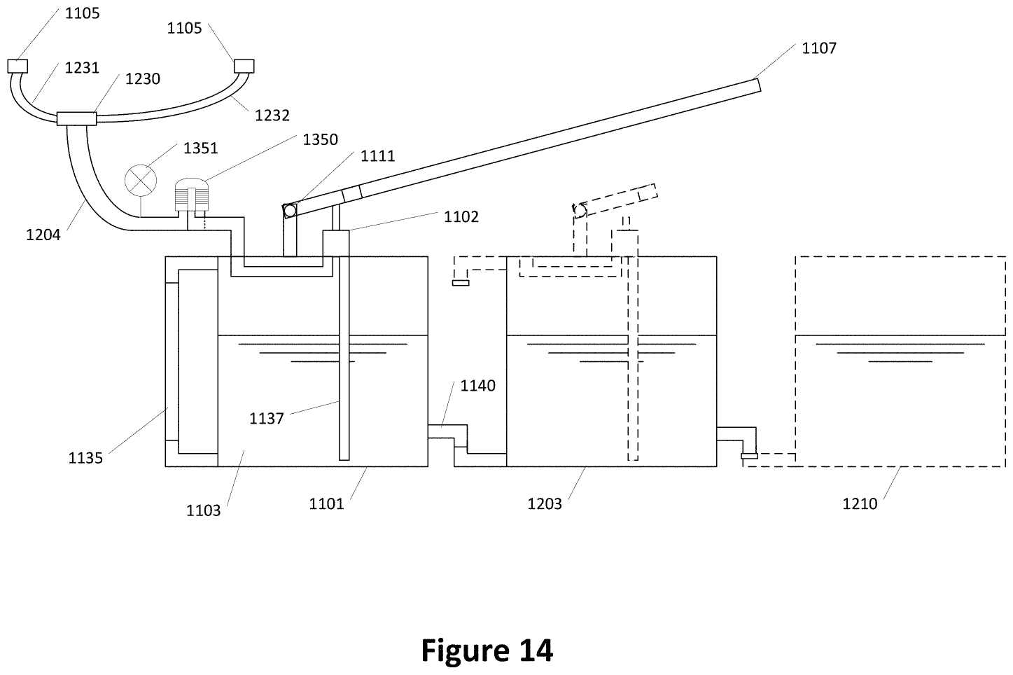

FIG. 13 shows servicing tool 1101 according to an exemplary embodiment. In this embodiment, the servicing tool 1101 may further include a filter 1350 and a pressure gauge 1351. The filter 1350 may filter hydraulic fluid flowing between the pump 1102 and coupling 1105 via the hose 1104. The pressure gauge 1351 may be configured to measure and indicate the pressure of the hydraulic fluid within a connected strut. FIG. 14 shows an embodiment of the servicing tool 1101 of FIG. 12 that includes the filter 1350 and the pressure gauge 1351 of the embodiment illustrated in FIG. 13.

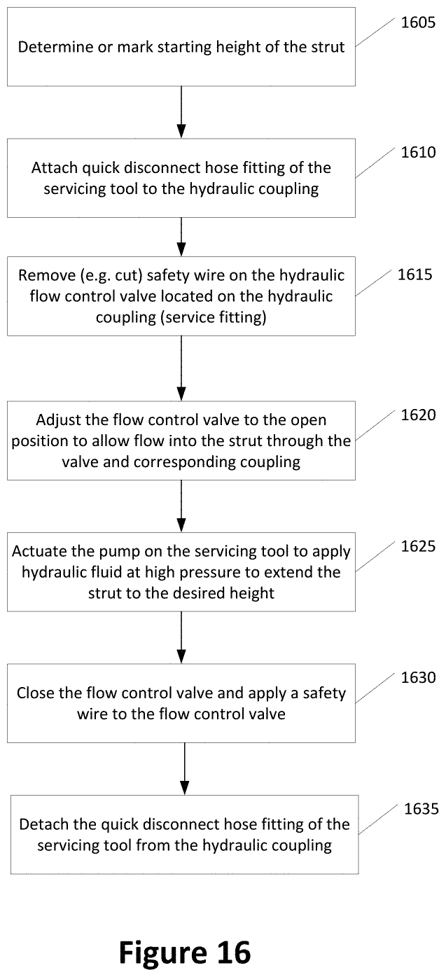

FIG. 16 shows a flowchart of a servicing method to raise a strut according to an exemplary embodiment of the present disclosure. Some or all of the operations of the servicing method may be performed using a servicing tool according to one or more exemplary embodiments of the disclosure. The order of the operations may be performed differently than the order shown, and/or two or more operations may be performed simultaneously.

The process begins at operation 1605, where the starting height of the strut is determined or marked. For example, the current height of the strut 120 and/or of the aircraft 121 may be measured. The current position (e.g. extension) of the strut 120 can be marked, for example, by placing a mark on the current extended position of the piston 1503.

At operation 1610, the quick disconnect coupling (e.g. 105, 705, 1105) of the hose (e.g. 104, 704, 804 1104, 1204) of the servicing tool (e.g. 101, 701, 1101) is connected to the hydraulic fluid coupling 106 of strut 120.

At operation 1615, the safety wire on the hydraulic flow control valve 122 located on the hydraulic fluid coupling 106 is removed. The safety wire is configured to prevent accidental adjustment of the hydraulic flow control valve 122. The safety wire may be cut off the hydraulic flow control valve 122 to remove the safety wire.

At operation 1620, the hydraulic flow control valve 122 is adjusted to the open position to allow the flow of hydraulic fluid into the strut 120 through the hydraulic flow control valve 122 and corresponding hydraulic fluid coupling 106.

At operation 1625, the pump (e.g. 102, 702, 1102) on the servicing tool (e.g. 101, 701, 1101) is actuated to pump the hydraulic fluid from the reservoir (e.g. 103, 703, 1103) into the strut 120. In an exemplary embodiment, the pumping of the hydraulic fluid provides the hydraulic fluid at high pressure (e.g. at 3000 psi or more) to extend the strut 120 to the desired height. In this example, the strut 120 may be a pressurized strut (e.g. having been previously pressurized by highly pressurized nitrogen gas). In one or more exemplary embodiments, the pumping of the hydraulic fluid is performed at a high pressure that is sufficient to overcome the force exerted by the pressurized gas and/or hydraulic fluid within the strut 120. By applying the hydraulic fluid at high pressure, the length of the strut 120 may be adjusted without the application of additional high-pressure compressed gas. In one or more exemplary embodiments, the pumping of the hydraulic fluid is performed at 3500 psi, but is not limited thereto. Further, with the application of hydraulic fluid at high pressure to extend the strut 120, the stiffness of the strut 120 can be increased. The increased stiffness of the strut 120 advantageously reduces a risk of dynamic rollover that may be caused by extended struts having overly springing movements. For example, in aspects where the strut(s) 120 adjusted to allow installation of a water tank below the aircraft, the aircraft may be operated with the struts in the extended configuration. The aircraft may be more subject to dynamic rollover if the struts have increased springiness/elastic response in the extended confirmation. The use of struts with increased stiffness reduces the risk of dynamic rollover.

At operation 1630, the hydraulic flow control valve 122 is adjusted to the closed position to prevent the flow of hydraulic fluid into/out of the strut 120 through the hydraulic flow control valve 122 and corresponding hydraulic fluid coupling 106. The safety wire may be rethreaded into the hydraulic flow control valve 122 (e.g., the previously removed safety wire may be reused), or a new safety wire may be threaded into the hydraulic flow control valve 122, to prevent unintended adjustment of the hydraulic flow control valve 122. In one or more aspects, the application of the safety wire may alternatively be performed after operation 1635.

At operation 1635, the quick disconnect coupling (e.g. 105, 705, 1105) of the hose (e.g. 104, 704, 804 1104, 1204) of the servicing tool (e.g. 101, 701, 1101) may be disconnected from the hydraulic fluid coupling 106 of strut 120. In one or more aspects, the servicing tool may remain connected to the strut 120 until the height of the strut 120 is to be readjusted (e.g. lowered). The operation(s) of the method may be repeated if necessary.

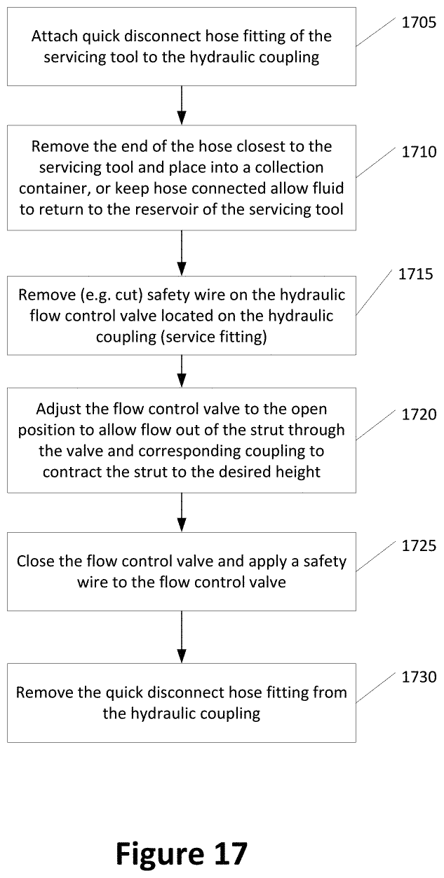

FIG. 17 shows a flowchart of a servicing method to lower a strut according to an exemplary embodiment of the present disclosure. Some or all of the operations of the servicing method may be performed using a servicing tool according to one or more exemplary embodiments of the disclosure. The order of the operations may be performed differently than the order shown, and/or two or more operations may be performed simultaneously.

The process begins at operation 1705, where the quick disconnect coupling (e.g. 105, 705, 1105) of the hose (e.g. 104, 704, 804 1104, 1204) of the servicing tool (e.g. 101, 701, 1101) is connected to the hydraulic fluid coupling 106 of strut 120.

At operation 1710, the end of the hose (e.g. 104, 704, 804 1104, 1204) connected to the servicing tool (e.g. 101, 701, 1101) may be disconnected and placed in or connected to a collection container. Alternatively, the hose may remain connected to the servicing tool to allow hydraulic fluid within the strut 120 to empty into the reservoir of the servicing tool. In this example, a flow control valve of the servicing tool can be adjusted to allow a reverse flow of hydraulic fluid through the pump and into the reservoir.

At operation 1715, the safety wire on the hydraulic flow control valve 122 located on the hydraulic fluid coupling 106 is removed. The safety wire may be cut off the hydraulic flow control valve 122 to remove the safety wire.

At operation 1720, the hydraulic flow control valve 122 is adjusted to the open position to allow the flow of hydraulic fluid from the strut 120 through the hydraulic flow control valve 122 and corresponding hydraulic fluid coupling 106 and into the hose, which may then empty the fluid into the collection container (or reservoir if the hose remains connected to the servicing tool).

At operation 1725, the hydraulic flow control valve 122 is adjusted to the closed position to prevent the flow of hydraulic fluid out of the strut 120 through the hydraulic flow control valve 122 and corresponding hydraulic fluid coupling 106. The safety wire may be rethreaded into the hydraulic flow control valve 122, or a new safety wire may be threaded into the hydraulic flow control valve 122, to prevent unintended adjustment of the hydraulic flow control valve 122. In one or more aspects, the application of the safety wire may alternatively be performed after operation 1730.

At operation 1730, the quick disconnect coupling (e.g. 105, 705, 1105) of the hose (e.g. 104, 704, 804 1104, 1204) of the servicing tool (e.g. 101, 701, 1101) may be disconnected from the hydraulic fluid coupling 106 of strut 120. The operation(s) of the method may be repeated if necessary.

According to one or more exemplary embodiments, the servicing tool may include one or more of the following components or equivalents.

Hydraulic hand pump: 50092 with quick disconnect: 00624-3305-4, MK1930 with or without pressure relief valve, and/or WHP-21-DA #42826.

Reservoir: Cylinder (e.g., fire extinguisher with open end NSN 6830-00-555-8837, P/N: M151, M35; and/or WHP-T-180 0.8 gallons).

Cap: 41228 3½″ plastic.

Union: 8MJ8 MB.

Union: MS21926D4.

Jam nut: AS5179D4 with O-ring.

Hydraulic Line: SS43D02A240000 ⅜″ 24″(long) braided high-pressure line.

Pump handle: 1″ diameter×20″ length pipe stock.

Storage case/container: 1021708 5 Gal (e.g., by Project Source).

Base: ¾″ plywood.

Support: 1″×4″ wood board.

Attachment devices attaching Support to Base and hand pump to Base (or to Support directly): bolts/nuts and/or wood screws 1″, 1¼″.

Hydraulic hand pump: may be a hand or foot-operated pump designed to pump fluid between 1000-25000 PSI.

Quick disconnect: may be any metal coupling designed for fast connection and disconnection while keeping lines sealed.

Reservoir: may be used as an open reservoir made of metal and/or plastic (or any other material or combination of materials) to allow the storage of hydraulic fluid while extending the strut. It is also used to capture fluid while draining the strut.

Cap: may comprise any item made of plastic or rubber that can be used as a lid or top to protect the contents.

Union: may comprise any fitting designed to bring to lines/bodies or connecting the combination of lines or bodies for a fluid system.

Jam nut: may comprise any nut designed to secure a fitting into place

O-Ring: may comprise any circular seal constructed of a multitude of materials whose purpose is to seal a fitting, boss, line, tube or union.

Hydraulic line: may comprise any tube that is capable of carrying fluid from one place to another. It is specifically constructed to withstand pressures of 50-25000 psi.

Pump handle: may comprise any metal tube structure with sufficient wall thickness at a diameter of ¾″-1½″ varying in length from 5″ to 48″. May comprise a single length of material or separable into lengths storable in the storage case and reconnectable for use.

Storage case/container: may be any structure constructed from plastics or metal that has sufficient space to store in the capacity of 3-10 Gal

Base: may comprise any material, e.g., wood, plastic, and/or metal (or a combination of materials) that has sufficient strength and thickness to support the mechanical action of operating the manual hydraulic pump.

Support: may comprise any material, e.g., wood, plastic and/or metal (or any other material or combination of materials) that has sufficient strength and thickness to support the mechanical action of operating the manual hydraulic pump.

Fastener: may comprise any type of fastener (e.g., wood screws, bolts, bolts and nuts, latches, buckles, etc.) that is used to join the base and support material together.

Demarcation/indicia inside reservoir: may be included to identify, based on a relative difference between a diameter of a reservoir and a diameter of a strut, a movement amount of the strut based on a change in height of fluid in the reservoir. For instance, where the diameter of the reservoir matches the diameter of the strut, a ratio of movement of the strut to the change in height of the fluid in the reservoir may be approximately 1:1 (e.g., for every inch in a change in height of the fluid in the reservoir, the strut may travel a corresponding inch).

The indicia in the reservoir or outside the reservoir (e.g., in a tube with a window or a window permitting viewing into the reservoir) may include multiple sets. For example, for a reservoir of 4 inches, the indicia may include scales identifying the relative movement of the strut per internal diameter of the strut. The following table shows examples of scales relative to a change in height of the fluid in the reservoir:

| Reservoir | Strut | Strut | Strut |
|---|---|---|---|
| Diameter | Diameter | Diameter | Diameter |
| 4 inches | 4 inches | 3 inches | 2 inches |
| Fluid Height | Strut | Strut | Strut |
| Movement | Movement | Movement | Movement |
| 0 | 0 | 0.00 | 0.00 |
| 0.5 | 0.5 | 0.89 | 2.00 |
| 1 | 1 | 1.78 | 4.00 |
| 1.5 | 1.5 | 2.67 | 6.00 |
| 2 | 2 | 3.56 | 8.00 |
| 2.5 | 2.5 | 4.44 | 10.00 |
| 3 | 3 | 5.33 | 12.00 |
| 3.5 | 3.5 | 6.22 | 14.00 |
| 4 | 4 | 7.11 | 16.00 |
| 4.5 | 4.5 | 8.00 | 18.00 |
| 5 | 5 | 8.89 | 20.00 |
| 5.5 | 5.5 | 9.78 | 22.00 |
| 6 | 6 | 10.67 | 24.00 |
| 6.5 | 6.5 | 11.56 | 26.00 |
| 7 | 7 | 12.44 | 28.00 |
| 7.5 | 7.5 | 13.33 | 30.00 |
| 8 | 8 | 14.22 | 32.00 |
| 8.5 | 8.5 | 15.11 | 34.00 |
| 9 | 9 | 16.00 | 36.00 |
| 9.5 | 9.5 | 16.89 | 38.00 |
| 10 | 10 | 17.78 | 40.00 |
| 10.5 | 10.5 | 18.67 | 42.00 |
| 11 | 11 | 19.56 | 44.00 |
| 11.5 | 11.5 | 20.44 | 46.00 |
| 12 | 12 | 21.33 | 48.00 |
| 12.5 | 12.5 | 22.22 | 50.00 |
| 13 | 13 | 23.11 | 52.00 |
| 13.5 | 13.5 | 24.00 | 54.00 |
| 14 | 14 | 24.89 | 56.00 |
| 14.5 | 14.5 | 25.78 | 58.00 |
| 15 | 15 | 26.67 | 60.00 |
| 15.5 | 15.5 | 27.56 | 62.00 |
| 16 | 16 | 28.44 | 64.00 |
| 16.5 | 16.5 | 29.33 | 66.00 |
| 17 | 17 | 30.22 | 68.00 |
| 17.5 | 17.5 | 31.11 | 70.00 |
| 18 | 18 | 32.00 | 72.00 |
| 18.5 | 18.5 | 32.89 | 74.00 |
| 19 | 19 | 33.78 | 76.00 |
| 19.5 | 19.5 | 34.67 | 78.00 |
| 20 | 20 | 35.56 | 80.00 |

Corresponding indicia may be provided for fluid height movement in millimeters and/or for struts having diameters in different scales (e.g., millimeters with a reservoir diameter in inches)

For a pump without a relief valve, a relief valve may be added via a coupling and/or in one of the pressure lines. Further, inlet and/or outlet screens may be added as desired.

Further, the volume per stroke may be identified to provide, for instance, a relative strut movement based on the number of full piston strokes of the pump.

The storage case/container may optionally include extensions to help stabilize the support case/container from side-to-side and/or rotational movement while the tool is being attached to or removed from the strut and/or during operation.

By changing the coupling to one compatible with brake fluid lines, brake fluid (e.g., Royco 782) may be bled using the servicing tool.

Examples of struts for aircraft that may be used with the tool may include the following, but are not limited to:

UH-60 Black Hawk: YUH-60A, UH-60A Black Hawk, UH-60C Black Hawk, CH-60E, UH-60L Black Hawk, UH-60V Black Hawk, UH-60M Black Hawk, UH-60M Upgrade Black Hawk, EH-60A Black Hawk, YEH-60B Black Hawk, EH-60C Black Hawk, EUH-60L, EH-60L Black Hawk, UH-60Q Black Hawk, HH-60L, HH-60M Black Hawk, HH-60U, HH-60W Jolly Green II, MH-60A Black Hawk, MH-60K Black Hawk, MH-60L Black Hawk, MH-60L DAP, MH-60M Black Hawk, MH-60 Black Hawk stealth helicopter, UH-60A RASCAL, VH-60N, OPBH, VH-60D Night Hawk, HH-60D, VH-60N, White Hawk, and/or VH-60M Black Hawk.

Export versions: UH-60J Black Hawk, S-70-12.UH-60JA Black Hawk, AH-60L Arpia, AH-60L Battle Hawk, UH-60P, S-70A Black Hawk, S-70A-1 Desert Hawk, S-70A-L1 Desert Hawk, S-70A-5 Black Hawk, S-70A-6 Black Hawk, S-70A-9 Black Hawk, S-70A-11 Black Hawk, S-70A-12 Black Hawk, UH-60J, S-70A-14 Black Hawk, S-70A-16 Black Hawk, S-70A-17 Black Hawk, S-70A-18 Black Hawk, UH-60P, HH-60P, S-70-19 Black Hawk, WS-70, S-70A-20 Black Hawk, S-70A-21 Black Hawk, S-70A-22 Black Hawk, VH-60P, HH-60P, S-70A-24 Black Hawk, S-70A-26 Black Hawk, S-70A-27 Black Hawk, S-70A-28D Black Hawk, S-70A-30 Black Hawk, S-70A-33 Black Hawk, S-70A-39 Black Hawk, S-70A-42 Black Hawk, S-70A-43 Black Hawk, S-70A-50 Black Hawk, S-70C-2 Black Hawk, S-70i Black Hawk, and/or S-70M Black Hawk.

Sikorsky: SH-60/MH-60 Seahawk, SH-60B, SH-60F, HH-60H, MH-60R, MH-605, YSH-60B Seahawk, SH-60B Seahawk, NSH-60B Seahawk, H-60E, SH-60F “Oceanhawk”, NSH-60F Seahawk, HH-60H “Rescue Hawk”, XSH-60J, SH-60J, YSH-60R Seahawk, MH-60R, YCH-60S “Knighthawk”, MH-60S “Knighthawk”, HH-60J/MH-60T Jayhawk, HH-60H, MH-60TS-70B Seahawk, S-70B-1 Seahawk, S-70B-2 Seahawk, S-70B-3 Seahawk, SH-60J, S-70-4, S-70-5 Seahawk, S-70B-6 Aegean Hawk, S-70B-7 Seahawk, S-70B-28, S-70C, S-70C(M)-½ Thunderhawk, S-70C(M)-2, S-70C-2, S-70C-6 Super Blue Hawk, S-70C-14, S-70A (N) Naval Hawk, and/or S-70L.

Pave Hawk: HH-60A, HH-60D Night Hawk, HH-60E, HH-60G Pave Hawk, MH-60G Pave Hawk, Maplehawk, and/or HH-60P Pave Hawk.

Coast Guard: HH-60J, MH-60T, H-60, AH-60 Arpia III, AH-60 Arpia IV, UH-60 Black Hawk, MH-60A, K, L, and M VH-60 White Hawk, SH-60 Seahawk, Sikorsky MH-60R Seahawk, Sikorsky MH-60S, HH-60 Pave Hawk, MH-60G Pave Hawk, and/or HH-60 Jayhawk.

S70: S-70C Firehawk, S-70A Black Hawk, S-70A Firehawk, S-70A (N) Naval Hawk, S-70B/C Seahawk, S-70A-9, S-70C Firehawk, S-70i Black Hawk, T-70, S-70M Black Hawk, and/or Sikorsky 5-71.

S92: Sikorsky 5-92, H-92 Superhawk, Sikorsky CH-148 Cyclone, and/or Sikorsky VH-92.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

1. A method for servicing a strut using a servicing tool, comprising:
connecting the servicing tool to a hydraulic coupling of the strut, wherein the strut has been previously filled with hydraulic fluid and pressurized gas at a gas pressure;
adjusting a hydraulic flow control valve to an open position to allow flow of hydraulic fluid into the strut through the hydraulic flow control valve;
actuating the servicing tool to pump hydraulic fluid into the strut via the hydraulic coupling to extend a height of the strut, the hydraulic fluid being pumped into the strut at a hydraulic pressure that is greater than the gas pressure;
adjusting the hydraulic flow control valve to a closed position to restrict flow of hydraulic fluid into and/or out of the strut through the hydraulic flow control valve; and
disconnecting the servicing tool from the hydraulic coupling of the strut.

2. The method according to claim 1, wherein the hydraulic pressure is at least 3000 pounds per square inch.

3. The method according to claim 1, wherein the hydraulic pressure is configured to overcome a force exerted by the pressurized gas within the strut.

4. The method according to claim 1, wherein the coupling is a quick-disconnect coupling.

5. The method according to claim 1, further comprising removing a safety wire from the hydraulic flow control valve to allow the adjustment of the hydraulic flow control valve.

6. The method according to claim 5, further comprising applying the safety wire to the hydraulic flow control valve following the adjustment of the hydraulic flow control valve to the closed position.

7. The method according to claim 1, further comprising:
reconnecting the servicing tool to the hydraulic coupling of the strut;
adjusting the hydraulic flow control valve to at least partially open the hydraulic flow control valve to allow at least a partial flow of the hydraulic fluid within the strut to flow out of the strut through the hydraulic flow control valve and into the servicing tool;
adjusting the hydraulic flow control valve to the closed position to restrict flow of hydraulic fluid out of the strut through the hydraulic flow control valve; and
disconnecting the servicing tool from the hydraulic coupling of the strut.

8. The method according to claim 7, further determining a height of the strut before actuating the servicing tool, wherein the adjustment of the hydraulic flow control valve to the closed position is performed in response to the strut retracting to the height of the strut before actuating the servicing tool.

9. The method according to claim 1, further comprising:
connecting a hydraulic line to the hydraulic coupling of the strut;
adjusting the hydraulic flow control valve to at least partially open the hydraulic flow control valve to allow at least a partial flow of the hydraulic fluid within the strut to flow out of the strut through the hydraulic flow control valve and hydraulic line;
adjusting the hydraulic flow control valve to the closed position to restrict flow of hydraulic fluid out of the strut through the hydraulic flow control valve; and
disconnecting the hydraulic line from the hydraulic coupling of the strut.

10. A strut servicing system, comprising:
a strut having previously been filled with hydraulic fluid and pressurized gas at a gas pressure; and
a strut servicing tool configured to adjust a height of the strut by pumping additional hydraulic fluid into the strut at a hydraulic pressure that is greater than the gas pressure of the pressurized gas.

11. The strut servicing system according to claim 10, wherein the strut servicing tool comprises:
a reservoir configured to contain the additional hydraulic fluid;
a hydraulic fluid line having a coupling configured to removably couple the hydraulic fluid line to a hydraulic service fitting of the strut; and
a pump that is configured to pump the additional hydraulic fluid from the reservoir and through the hydraulic fluid line to fill the strut with the additional hydraulic fluid to increase the height of the strut.

12. The system according to claim 10, wherein the hydraulic pressure is at least 3000 pounds per square inch.

13. The system according to claim 10, wherein the hydraulic pressure is configured to overcome a force exerted by the pressurized gas within the strut.

14. The system according to claim 11, wherein the coupling is a quick-disconnect coupling.

15. A strut servicing tool operable to service a pressurized strut containing hydraulic fluid and pressurized gas at a gas pressure, comprising:
a reservoir configured to contain hydraulic fluid;
a hydraulic fluid line having a coupling configured to removably couple the hydraulic fluid line to a strut; and
a pump that is configured to pump the hydraulic fluid from the reservoir and through the hydraulic fluid line to fill the strut with hydraulic fluid, at a hydraulic pressure that is greater than the gas pressure of the pressurized gas, to increase a height of the strut.

16. The tool according to claim 15, wherein the hydraulic pressure is at least 3000 pounds per square inch.

17. The tool according to claim 15, wherein the hydraulic pressure is configured to overcome a force exerted by pressurized gas within the strut.

18. The tool according to claim 15, wherein the coupling is a quick-disconnect coupling.
